(19) United States
(12) Patent Application Publication
(10) Pub. No.: US 2026/0284518 A1
(43) Pub. Date: Sep. 24, 2026

(54) ONE OR MORE NON-TRANSITORY COMPUTER-READABLE STORAGE MEDIA, INFORMATION PROCESSING SYSTEM, AND COMPUTER-IMPLEMENTED METHOD

(71) Applicant: Nintendo Co., Ltd., Kyoto-shi (JP)

(72) Inventors: Masato ORISHIGE, Kyoto (JP); Yoshinori KONISHI, Kyoto (JP)

(21) Appl. No.: 19/684,727

(22) Filed: May 21, 2026

Related U.S. Application Data
(63) Continuation of application No. PCT/JP2024/009834, filed on Mar. 13, 2024.

(51) Int. Cl. A63F 13/22; A63F 13/211; A63F 13/2145; A63F 13/533

(52) U.S. Cl. CPC A63F 13/22; A63F 13/533; A63F 13/211; A63F 13/2145

(57) ABSTRACT

In a mouse operation mode, a first indicator that points to an item displayed is moved in accordance with first mouse operation data of a first input device held by the left hand of a user and second mouse operation data of a second input device held by the right hand of the user. In a direction input operation mode, a second indicator that points to the above item is moved in accordance with first direction input section operation data of the first input device, and the second indicator is not moved in accordance with second direction input section operation data of the second input device. Either the mouse operation mode or the direction input operation mode is executed.

### CROSS REFERENCE TO RELATED APPLICATION

This application is a continuation of International Application No. PCT/JP 2024/009834, filed on Mar. 13, 2024, the entire contents of which are incorporated herein by reference.

### FIELD

The present disclosure relates to information processing.

### BACKGROUND AND SUMMARY

Conventionally, an input device including a pointing device and a non-pointing device has been known.

A novel control method for object display, using an input device, has been desired.

For example, the following configuration examples are exemplified.

One configuration example is directed to one or more non-transitory computer-readable storage media having stored therein instructions that, when executed, cause one or more processors to perform game operations including: acquiring, from a first input device that has a first direction input section and a first mouse sensor and is held by the left hand of a user, first direction input section operation data in response to an operation performed to the first direction input section by the user, and first mouse operation data in response to movement of the first input device by the user; acquiring, from a second input device that has a second direction input section and a second mouse sensor and is held by the right hand of the user, second direction input section operation data in response to an operation performed to the second direction input section by the user, and second mouse operation data in response to movement of the second input device by the user; in a mouse operation mode, moving a first indicator that points to an item displayed, in accordance with the first mouse operation data and the second mouse operation data; in a direction input operation mode, moving a second indicator that points to the item displayed, in accordance with the first direction input section operation data, without moving the second indicator in accordance with second direction input section operation data; and executing either the mouse operation mode or the direction input operation mode.

According to the above configuration example, in the mouse operation mode, the first indicator can be mouse-operated using either the first input device operated by the left hand or the second input device operated by the right hand, thereby improving operability. Furthermore, generally, when the user holds an input device by both hands (holding one input device by both hands, holding two input devices by the left hand and the right hand, respectively, etc.), a direction input operation is performed using the left thumb in many cases. Therefore, in the above configuration example, control is performed such that the second indicator is moved by the direction input operation performed on the first input device held by the left hand while the second indicator is not moved by the direction input operation performed to the second input device held by the right hand, thereby providing operation without any discomfort or confusion.

In another configuration example, the game operations may include executing: a gameplay state in which the first indicator and the second indicator are not displayed, and which is progressed in accordance with the first mouse operation data and the second mouse operation data; and a menu state which is transitioned to from the gameplay state, and in which either the mouse operation mode or the direction input operation mode is executed.

According to the above configuration example, when a transition is made from the gameplay state, in which operation is performed using both the first input device and the second input device, to the menu state, operation can continue to be performed in the menu state using both the first input device and the second input device as they are, thereby improving operability.

In another configuration example, the game operations may include causing the first indicator and the second indicator to be different indicators; not displaying the second indicator in the mouse operation mode, and not displaying the first indicator in the direction input operation mode; and setting the mode to the mouse operation mode when a transition is made from the gameplay state to the menu state.

According to the above configuration example, since one of the first indicator and the second indicator is displayed in accordance with the operation mode while the other indicator is not displayed, it is easy to recognize which operation mode is currently active. In addition, when a transition is made from the gameplay state, which progresses in response to a mouse operation, to the menu state, the operation mode becomes the mouse operation mode. As a result, the user can continue performing the mouse operation in the same manner as in the gameplay state to move the first indicator, thereby providing smooth operability when transitioning to the menu state.

In another configuration example, the game operations may include: executing the mouse operation mode when the first mouse operation data indicating movement of the first input device or the second mouse operation data indicating movement of the second input device is acquired; and executing the direction input operation mode when the first direction input section operation data indicating an operation input to the first direction input section is acquired.

According to the above configuration example, an additional operation is not required for switching between the mouse operation mode and the direction input operation mode, thereby improving operability.

In another configuration example, the game operations may include executing the mouse operation mode when at least one of the first mouse operation data and the second mouse operation data, and the first direction input section operation data are acquired.

In order for the user to perform a mouse operation, it is necessary to operate the input device with the surface on which a mouse sensor is provided being placed on a work surface. Therefore, when a mouse operation is performed, it is highly likely that the user intends to perform the mouse operation, and it is highly likely that the user does not intend to perform a direction input operation. Therefore, according to the above configuration example, it is possible to provide the operation mode that conforms to the user's intention.

In another configuration example, the first input device includes the first direction input section at a front surface, a first button at an upper surface or a left surface, and the first mouse sensor at a right surface, and the second input device includes the second direction input section and a second button at a front surface, a third button at an upper surface or a right surface, and the second mouse sensor at a left surface. The game operations include: in the mouse operation mode, assigning a determination function to the first button and the third button, and not assigning a determination function to the second button; and in the direction input operation mode, assigning a determination function to the second button, and not assigning a determination function to the first button and the third button.

According to the above configuration example, it is easy to perform a determination operation in the mouse operation mode, and it is easy to perform a determination operation in the direction input operation mode.

In another configuration example, the game operations may include, in the direction input operation mode, assigning a function of switching the item, to the first button and the third button.

According to the above configuration example, by assigning different functions to the first button and the third button in the mouse operation mode and the direction input operation mode, it is possible to provide operability without discomfort while efficiently using the buttons.

In another configuration example, the first indicator may be a first object, and the second indicator may be a second object different from the first object.

Each configuration example described above may be read as a configuration example of an information processing system or a computer-implemented method.

### BRIEF DESCRIPTION OF THE DRAWINGS

FIG. 1 shows a non-limiting example of a state in which a left controller 3 and a right controller 4 are attached to a main body apparatus 2;

FIG. 2 is six orthogonal views showing a non-limiting example of the left controller 3;

FIG. 3 is six orthogonal views showing a non-limiting example of the right controller 4;

FIG. 4 is a block diagram showing a non-limiting example of the internal configuration of the main body apparatus 2;

FIG. 5 is a block diagram showing a non-limiting example of the internal configurations of the main body apparatus 2, the left controller 3, and the right controller 4;

FIG. 6 illustrates a screen for a gameplay state;

FIG. 7 illustrates a way of holding a controller and an operation method for the controller in a gameplay state;

FIG. 8 illustrates a screen for a mouse operation mode in a menu state;

FIG. 9 illustrates a screen for a mouse operation mode in the menu state;

FIG. 10 illustrates a way of holding a controller and an operation method for the controller in the mouse operation mode;

FIG. 11 illustrates a screen for a direction input operation mode in the menu state;

FIG. 12 illustrates a screen for a direction input operation mode in the menu state;

FIG. 13 illustrates a way of holding a controller and an operation method for the controller in the direction input operation mode;

FIG. 14 shows a non-limiting example of various data stored in a DRAM 85;

FIG. 15 is a non-limiting example of a flowchart of information processing;

FIG. 16 is a non-limiting example of a flowchart of information processing;

FIG. 17 is a non-limiting example of a flowchart of information processing; and

FIG. 18 is a non-limiting example of a flowchart of information processing.

### DETAILED DESCRIPTION OF NON-LIMITING EXAMPLE EMBODIMENTS

Hereinafter, an exemplary embodiment will be described.

### Hardware Configuration of Information Processing Apparatus

Hereinafter, a game system which is an example of an information processing system of the exemplary embodiment will be described. An example of a game system 1 according to the exemplary embodiment includes an information processing apparatus (sometimes referred to as “main body apparatus”) 2, a left controller 3, and a right controller 4. The main body apparatus 2 allows the left controller 3 and the right controller 4 to be attached thereto and detached therefrom.

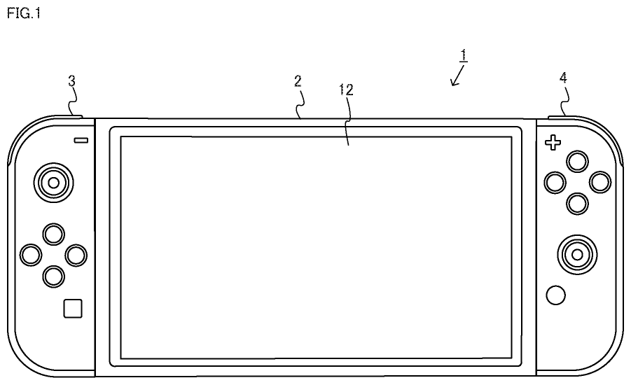

FIG. 1 is a diagram showing an example of a state where the left controller 3 and the right controller 4 are attached to the main body apparatus 2. As shown in FIG. 1, the left controller 3 and the right controller 4 are attached to and integrated with the main body apparatus 2. The main body apparatus 2 is an apparatus for executing various kinds of processing (e.g., game processing) in the game system 1. The main body apparatus 2 includes a display 12. The left controller 3 and the right controller 4 each include an operation portion on which a user performs input. Hereinafter, the left controller 3 and the right controller 4 are sometimes collectively referred to as “controller”. The left controller 3 may be referred to as “first input device” and the right controller 4 may be referred to as “second input device”.

The main body apparatus 2 includes a display 12. The display 12 displays images generated by the main body apparatus 2. The display 12 is, for example, a liquid crystal display device (LCD). A touch panel is provided on the screen of the display 12. The touch panel is, for example, a type capable of receiving a multi-touch input (e.g., electrical capacitance type).

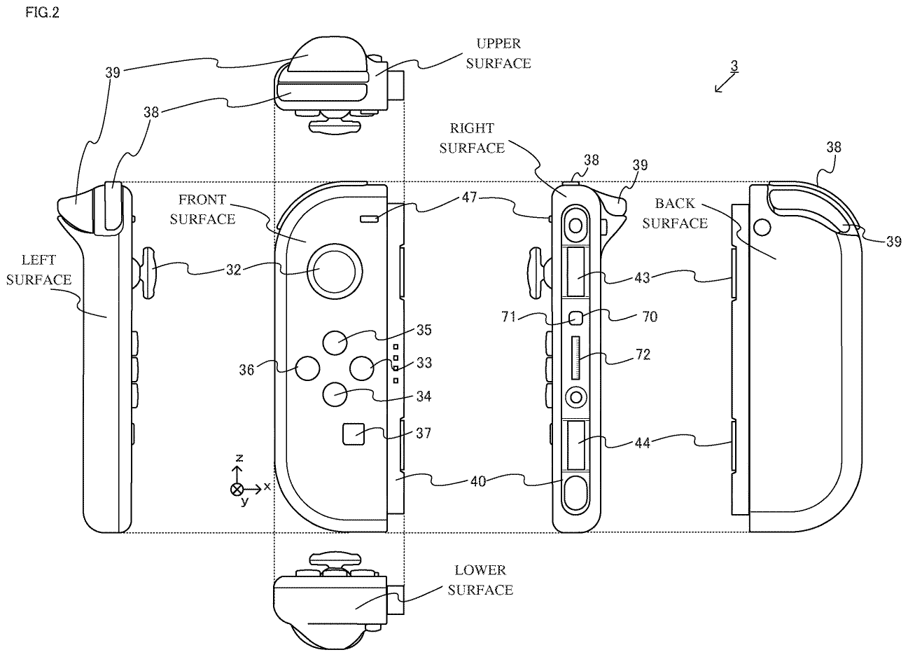

FIG. 2 shows six orthogonal views showing an example of the left controller 3. As shown in FIG. 2, the left controller 3 has a vertically long shape, that is, a shape that is long in a z-axis direction shown in FIG. 2. The left controller 3 has a protruding portion 40 to be fitted into a recessed portion (not shown) of the main body apparatus 2, in a state of being attached to the main body apparatus 2. The left controller 3 can be held in an orientation in which the left controller 3 is vertically long, in a state of being detached from the main body apparatus 2. The left controller 3 has such a shape and a size that the left controller 3 can be held by one hand, in particular, a left hand, in a case of being held in the orientation in which the left controller 3 is vertically long. The left controller 3 can also be held by both hands in a case of being held in the orientation in which the left controller 3 is horizontally long.

The left controller 3 includes a left analog stick (sometimes referred to as “left stick”) 32 that is an example of a direction input device. As shown in FIG. 2, the left stick 32 is provided in a front surface of the left controller 3. The left stick 32 can be used as a direction input section with which a direction can be inputted. By tilting the left stick 32, the user can input a direction corresponding to the tilt direction and can input a magnitude corresponding to the angle of the tilt.

The left controller 3 has various operation buttons. The left controller 3 has a right direction button 33, a down direction button 34, an up direction button 35, a left direction button 36, a record button 37, and a “−” (minus) button 47, at the front surface. The left controller 3 has an L button 38 and a ZL button 39. The L button 38 and the ZL button 39 may be provided at only the upper surface of the left controller 3, or may be provided at only the left surface of the left controller 3. The left controller 3 has a button 43 and a button 44 at the protruding portion 40 on the right surface.

The left controller 3 has a mouse sensor opening 70 at the protruding portion 40 on the right surface. The mouse sensor opening 70 is an opening through which light is guided to the mouse sensor 71 provided inside. The mouse sensor 71 is, for example, a general mouse sensor (e.g., an optical-type or laser-type mouse sensor), and acquires data for calculating movement (movement direction, movement distance, movement speed, etc.), on a work surface, of the left controller 3 placed with the right surface (i.e., the upper surface of the protruding portion 40) facing the work surface.

The left controller 3 has, at the protruding portion 40 on the right surface, a terminal 72 for the left controller 3 to perform wired communication with the main body apparatus 2.

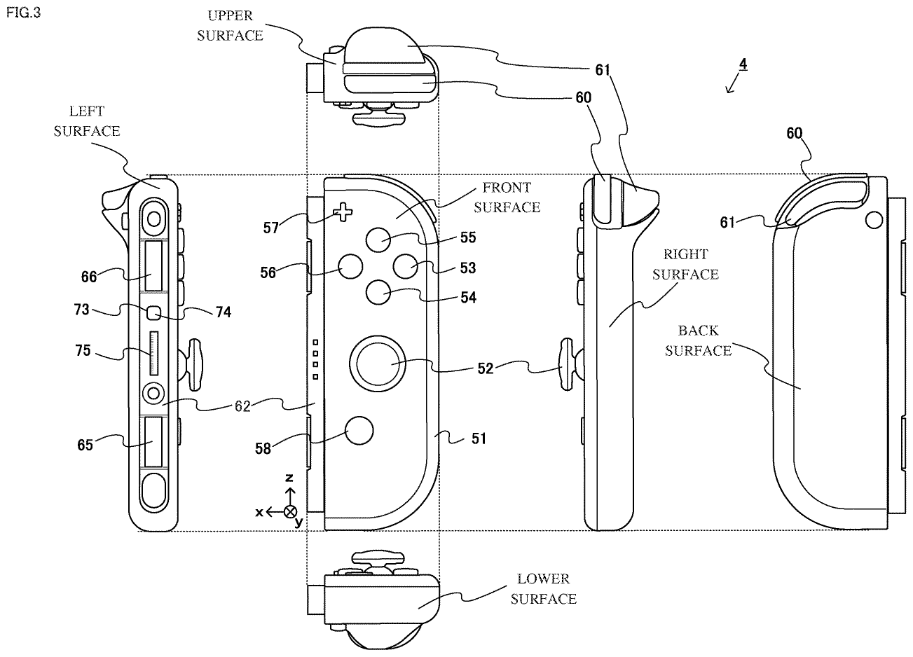

FIG. 3 shows six orthogonal views showing an example of the right controller 4. As shown in FIG. 3, the right controller 4 has a vertically long shape, that is, a shape that is long in a z-axis direction shown in FIG. 3. The right controller 4 has a protruding portion 62 to be fitted into a recessed portion (not shown) of the main body apparatus 2, in a state of being attached to the main body apparatus 2. The right controller 4 can also be held in the orientation in which the right controller 4 is vertically long, in a state of being detached from the main body apparatus 2. The right controller 4 has such a shape and a size that the right controller 4 can be held by one hand, in particular, a right hand, in a case of being held in the orientation in which the right controller 4 is vertically long. The right controller 4 can also be held by both hands in a case of being held in the orientation in which the right controller 4 is horizontally long.

The right controller 4 has a right analog stick (sometimes referred to as “right stick”) 52 as a direction input section, at the front surface. In the exemplary embodiment, the right stick 52 has the same configuration as the left stick 32 of the left controller 3. The right controller 4 has an A button 53, a B button 54, an X button 55, a Y button 56, a “+” (plus) button 57, and a button 58, at the front surface. The right controller 4 has an R button 60 and a ZR button 61 over a range from the upper surface to the right surface. The R button 60 and the ZR button 61 may be provided at only the upper surface of the right controller 4, or may be provided at only the right surface of the right controller 4. The right controller 4 has a button 65 and a button 66 at the protruding portion 62 on the left surface.

The right controller 4 has a mouse sensor opening 73 at the protruding portion 62 on the left surface. The mouse sensor opening 73 is an opening through which light is guided to a mouse sensor 74 provided inside. The mouse sensor 74 is, for example, a general mouse sensor (e.g., an optical-type or laser-type mouse sensor), and acquires data for calculating movement (movement direction, movement distance, movement speed, etc.), on a work surface, of the right controller 4 placed with the left surface (i.e., the upper surface of the protruding portion 62) facing the work surface.

The right controller 4 has, at the protruding portion 62 on the left surface, a terminal 75 for the right controller 4 to perform wired communication with the main body apparatus 2.

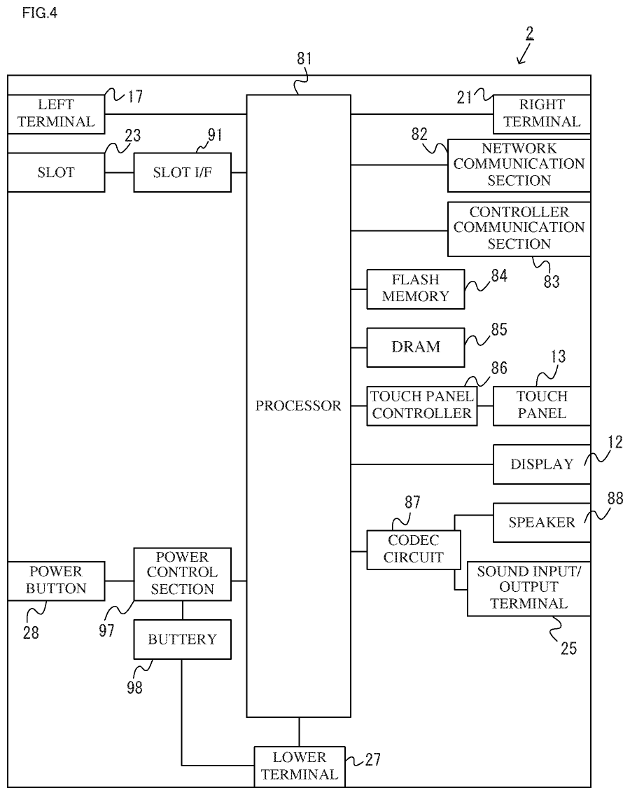

FIG. 4 is a block diagram showing an example of the internal configuration of the main body apparatus 2. The main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to a slot 23, or the like), thereby executing the various types of information processing.

The main body apparatus 2 includes the flash memory 84 and a DRAM (Dynamic Random Access Memory) 85 as examples of internal storage media. The flash memory 84 is a memory mainly used to store various data (or programs) to be saved in the main body apparatus 2. The DRAM 85 is a memory used to temporarily store various data used for information processing. The processor 81 appropriately reads and writes data from and to storage media such as the flash memory 84 and the DRAM 85, thereby executing various information processes.

Furthermore, the main body apparatus 2 includes various components, as shown in FIG. 4. These will be briefly described below. A slot interface (sometimes referred to as “slot I/F”) 91 performs reading/writing of data from/into a specified kind of storage medium (e.g., a dedicated memory card) attached to the slot 23, in response to an instruction from the processor 81. A network communication section 82 performs communication (e.g., Internet communication) with an external device via a network.

The controller communication section 83 performs wireless communication (e.g., communication compliant with the standard of Bluetooth (registered trademark)) with the left controller 3 and/or the right controller 4. A left terminal 17 is a terminal for performing data communication between the processor 81 and the left controller 3. A right terminal 21 is a terminal for performing data communication between the processor 81 and the right controller 4. A lower terminal 27 is a terminal for outputting data (e.g., image data and sound data) to a stationary monitor or the like via a cradle when the lower terminal 27 is attached to the cradle.

A touch panel controller 86 generates data indicating a position where, for example, a touch input was performed, based on a signal from a touch panel 13 disposed on the display surface of the display 12, and outputs the data to the processor 81. The display 12 displays an image generated by the processor 81 and/or an image acquired from the outside. A codec circuit 87 controls input and output of sound data to and from a speaker 88 and a sound input/output terminal 25. A power control section 97 controls supply of power from a battery 98 to each section of the main body apparatus 2 (i.e., each of sections to be supplied with power from the battery 98), based on an instruction from the processor 81, and starts or stops supply of power in response to pressing of a power button 28.

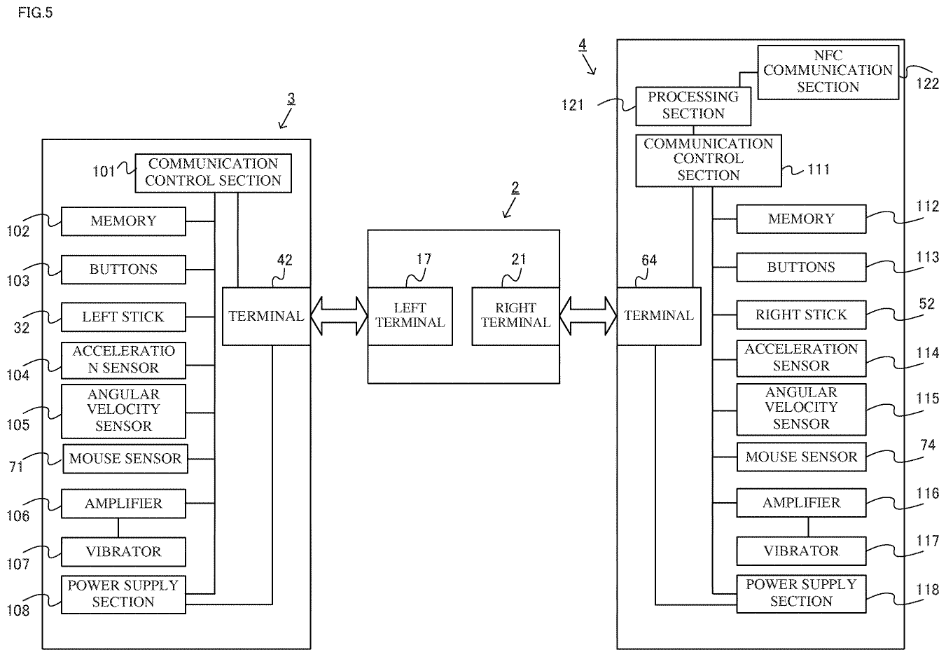

FIG. 5 is a block diagram showing examples of the internal configurations of the main body apparatus 2, the left controller 3, and the right controller 4. The details of the internal configuration of the main body apparatus 2 are shown in FIG. 4 and therefore are omitted in FIG. 5.

The left controller 3 includes a communication control section 101 which performs communication with the main body apparatus 2. As shown in FIG. 5, the communication control section 101 is connected to various components including a terminal 42. In a state where the left controller 3 is attached to the main body apparatus 2, the communication control section 101 performs communication with the main body apparatus 2 via the terminal 42, and in a state where the left controller 3 is detached from the main body apparatus 2, the communication control section 101 performs wireless communication with the main body apparatus 2.

The left controller 3 includes a memory 102 such as a flash memory. The communication control section 101 includes, for example, a microcomputer (or a microprocessor) and executes firmware stored in the memory 102, thereby executing various processes.

The left controller 3 has buttons 103 (specifically, buttons 33 to 36, etc.) and the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104 and an angular velocity sensor 105. In the exemplary embodiment, the acceleration sensor 104 detects the magnitudes of accelerations along specified three axial (e.g., x, y, z axes shown in FIG. 2) directions. The acceleration sensor 104 may detect an acceleration along one axial direction or accelerations along two axial directions. In the exemplary embodiment, the angular velocity sensor 105 detects angular velocities about specified three axes (e.g., the x, y, z axes shown in FIG. 2). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The left controller 3 includes a mouse sensor 71. The mouse sensor 71 acquires data for calculating movement (movement direction, movement distance, movement speed, etc.) of the left controller 3 on a work surface. Using this data, it is possible to determine whether the right surface of the left controller 3 is in contact with the work surface or in a state close to contact therewith (e.g., a state in which the gap between the right surface and the work surface is equal to or less than a specified distance (e.g., 1 mm)). The data acquired by the mouse sensor 71 is outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104, 105, and 71). The communication control section 101 transmits operation data including the acquired information or information obtained by performing specified processing on the acquired information, to the main body apparatus 2. The operation data is transmitted repeatedly, once every specified time.

The above operation data is transmitted to the main body apparatus 2, whereby the main body apparatus 2 can obtain inputs provided to the left controller 3. That is, the main body apparatus 2 can determine operations performed on the buttons 103 and the left stick 32, based on the operation data. Furthermore, the main body apparatus 2 can calculate information regarding the motion and/or the orientation of the left controller 3 based on the operation data (specifically, the detection results of the acceleration sensor 104 and the angular velocity sensor 105). The main body apparatus 2 can calculate information regarding a mouse operation performed on the left controller 3, based on operation data (specifically, a detection result from the mouse sensor 71).

The left controller 3 includes an amplifier 106 and a vibrator 107. The amplifier 106 amplifies control signals received from the communication control section 101 and generates drive signals. The vibrator 107 performs vibrating motion in response to the drive signals generated by the amplifier 106 to vibrate the left controller 3.

The left controller 3 includes a power supply section 108. The power supply section 108 includes a battery and a power control circuit. The power control circuit is connected to the battery, and is connected to each unit of the left controller 3 (specifically, each of units to be supplied with power from the battery).

As shown in FIG. 5, the right controller 4 includes a communication control section 111 that performs communication with the main body apparatus 2. The right controller 4 includes a memory 112 connected to the communication control section 111. The communication control section 111 is connected to components including the terminal 64. The communication control section 111 and the memory 112 have functions similar to those of the communication control section 101 and the memory 102 of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls communication performed by the right controller 4 with the main body apparatus 2.

The right controller 4 has input sections similar to those of the left controller 3. Specifically, the right controller 4 has buttons 113 (A button 53, B button 54, X button 55, Y button 56, etc.), the right stick 52, inertial sensors (an acceleration sensor 114 and an angular velocity sensor 115), and the mouse sensor 74. These input sections may have the same functions as those of the left controller 3, and may operate in the same manner.

The right controller 4 includes an amplifier 116, a vibrator 117, and a power supply section 118. The amplifier 116, the vibrator 117, and the power supply section 118 have the same functions as the amplifier 106, the vibrator 107, and the power supply section 108, respectively, of the left controller 3, and operate in the same manner.

The right controller 4 includes a processing section 121 and an NFC communication section 122. The processing section 121 controls the NFC communication section 122 in response to an instruction from the main body apparatus 2 via the communication control section 111. The NFC communication section 122 performs short-range wireless communication based on the standard of NFC (Near Field Communication).

### Game Assumed in Exemplary Embodiment

Next, the outline of game processing executed by the game apparatus (game system) 1 according to the exemplary embodiment will be described. A game assumed in the exemplary embodiment is, as an example, a wheelchair basketball game played in a multiplayer format by three users against three users. Specifically, player objects (objects each representing a wheelchair with a person riding thereon; sometimes referred to as “PO”) move, etc., within a virtual space in which a court and a goal of the wheelchair basketball game are arranged, in response to operations performed by the respective players, to play the wheelchair basketball game. Some of the POs may be non-player objects that are automatically controlled. In addition, this game may be a game in which one PO appears. This game is not limited to the wheelchair basketball game and may be another type of game. For example, this game may be a boat game in which an object is operated such that a person rides on a boat, moves an oar that cuts through the water on the left side of the boat with the left hand, and moves an oar that cuts through the water on the right side of the boat with the right hand.

In this game, a gameplay state and a menu state exist. The user can play the wheelchair basketball game in the gameplay state, and can perform various settings regarding this game in the menu state. The gameplay state and the menu state are switched in response to a user operation.

### Outline of Game Processing of Exemplary Embodiment

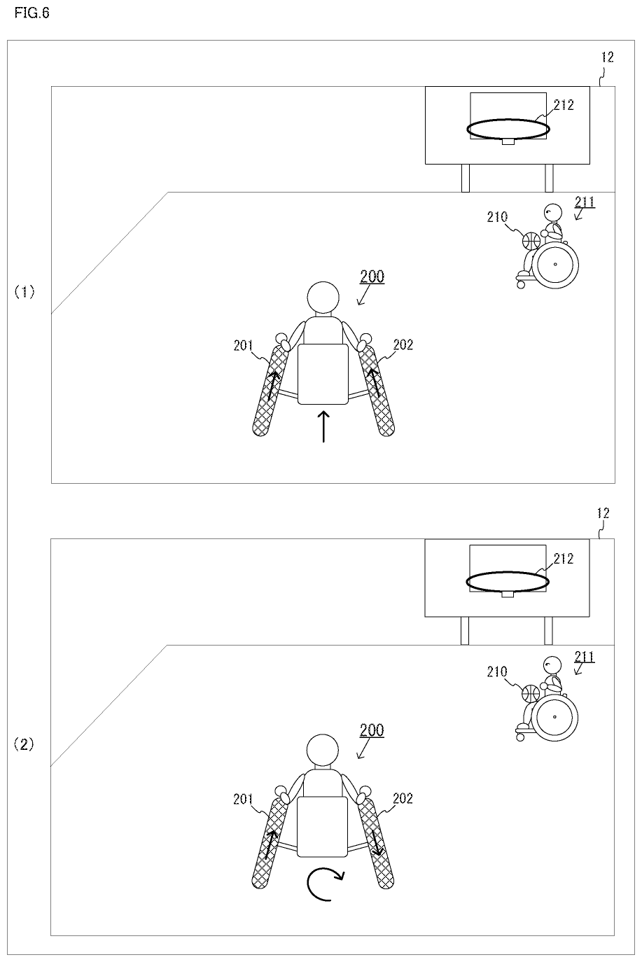

Next, the outline of processing executed in the game apparatus 1 according to the exemplary embodiment will be described. FIG. 6 shows an example of a display screen in a gameplay state. In FIG. 6, on the game apparatus 1, a PO 200 operated by the user, a PO 211 operated by another user with another game apparatus 1, a ball 210, a goal 212, and the like are displayed.

### Gameplay State

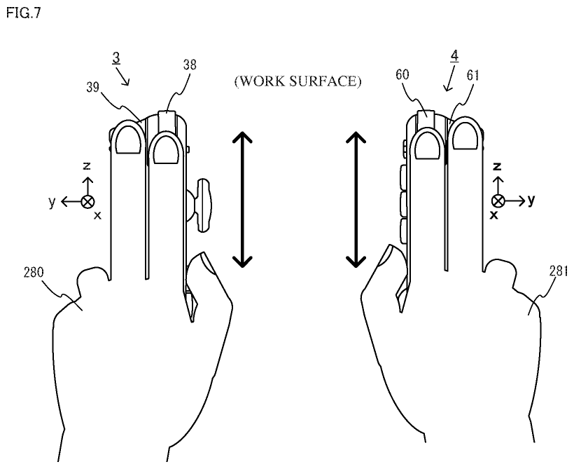

FIG. 7 illustrates an operation performed by the user in the gameplay state to, for example, move the PO 200 in the virtual space. As shown in FIG. 7, in the gameplay state, the user can grip the left controller 3 by pinching it with the thumb, ring finger, and little finger of the left hand 280, place the index finger on the L button 38, and place the middle finger on the ZL button 39. Likewise, the user can grip the right controller 4 by pinching it with the thumb, ring finger, and little finger of the right hand 281, place the index finger on the R button 60, and place the middle finger on the ZR button 61.

Then, as shown in FIG. 7, the user can perform an operation of moving the left controller 3 with the right surface of the left controller 3 (see FIG. 2) in contact with the work surface, and moving the right controller 4 with the left surface of the right controller 4 (see FIG. 3) in contact with the work surface. By doing so, the user can perform a mouse operation (also referred to as “mouse input operation”) in which the left controller 3 and the right controller 4 are operated as mice. In addition, while performing the mouse operation, the user can perform an operation of pressing the L button 38 and the ZL button 39 of the left controller 3 and an operation of pressing the R button 60 and the ZR button 61 of the right controller 4.

In the gameplay state, the user can move the PO 200 and change the direction of the PO 200 by rotating the wheels of the wheelchair of the PO 200 through a mouse operation of the left controller 3 and/or the right controller 4. Details will be described below.

When a mouse operation of moving the left controller 3 in the z-axis positive direction (see FIG. 2, FIG. 7) is performed on the work surface, a left wheel 201 of the wheelchair rotates in the direction in which the PO 200 moves forward. When a mouse operation of moving the right controller 4 in the z-axis positive direction (see FIG. 3, FIG. 7) is performed on the work surface, a right wheel 202 of the wheelchair rotates in the direction in which the PO 200 moves forward. When a mouse operation of moving the left controller 3 in the z-axis negative direction (see FIG. 2, FIG. 7) is performed on the work surface, the left wheel 201 of the wheelchair rotates in the direction in which the PO 200 moves backward. When a mouse operation of moving the right controller 4 in the z-axis negative direction (see FIG. 3, FIG. 7) is performed on the work surface, the right wheel 202 of the wheelchair rotates in the direction in which the PO 200 moves backward.

Therefore, when the mouse operation of moving the left controller 3 in the z-axis positive direction (see FIG. 2, FIG. 7) and the mouse operation of moving the right controller 4 in the z-axis positive direction (see FIG. 3, FIG. 7) are simultaneously performed, as shown in FIG. 6(1), both wheels of the wheelchair rotate in the direction in which the PO 200 moves forward, whereby the PO 200 moves forward. In this case, for example, if the movement speed of the right controller 4 in the z-axis positive direction is lower than the movement speed of the left controller 3 in the z-axis positive direction, the PO 200 moves forward while turning right.

When the mouse operation of moving the left controller 3 in the z-axis negative direction (see FIG. 2, FIG. 7) and the mouse operation of moving the right controller 4 in the z-axis negative direction (see FIG. 3, FIG. 7) are simultaneously performed, both wheels of the wheelchair rotate in the direction in which the PO 200 moves backward, whereby the PO 200 moves backward. In this case, for example, if the movement speed of the right controller 4 in the z-axis negative direction is lower than the movement speed of the left controller 3 in the z-axis negative direction, the PO 200 moves backward while turning left.

When the mouse operation of moving the left controller 3 in the z-axis positive direction (see FIG. 2, FIG. 7) and the mouse operation of moving the right controller 4 in the z-axis negative direction (see FIG. 3, FIG. 7) are simultaneously performed, the PO 200 rotates rightward as shown in FIG. 6(2). When the mouse operation of moving the left controller 3 in the z-axis negative direction (see FIG. 2, FIG. 7) and the mouse operation of moving the right controller 4 in the z-axis positive direction (see FIG. 3, FIG. 7) are simultaneously performed, the PO 200 rotates leftward.

As described above, in the gameplay state, the user can play the wheelchair basketball game by moving the PO 200 through the mouse operation using the left controller 3 and the right controller 4 on the work surface. In this case, the mouse operations corresponding to each controller (3, 4) do not cause any object, such as a mouse cursor, to be displayed or moved. The rotation of each wheel is merely an animation, and the movement direction and the movement speed of the PO 200 may be obtained independently of calculations related to the wheel rotation mode. In addition, by performing specified operations on the left controller 3 and/or the right controller 4, the user can shoot the ball 210 toward the goal 212 or take the ball 210 from another PO 211.

### Menu State

Next, the menu state of the exemplary embodiment will be described. When a plus button 57 of the right controller 4 is pressed in the gameplay state, a transition to the menu state is made. When the plus button 57 of the right controller 4 is pressed in the menu state, a transition to the gameplay state is made. The menu state is a mode in which the user performs settings related to this game. The menu state includes a mouse operation mode and a direction input operation mode. The mode is switched between the mouse operation mode and the direction input operation mode in response to user operations. Details will be described below.

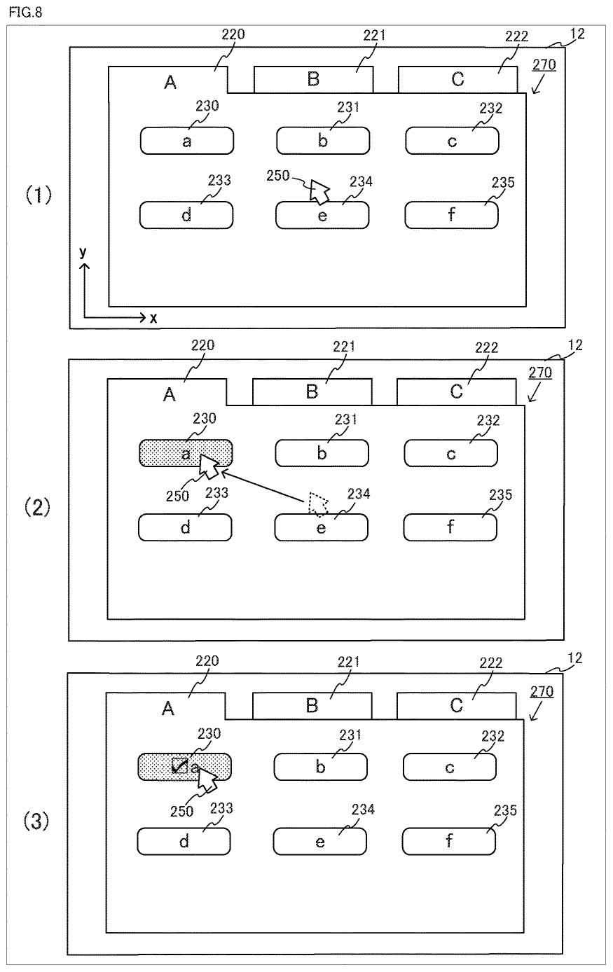

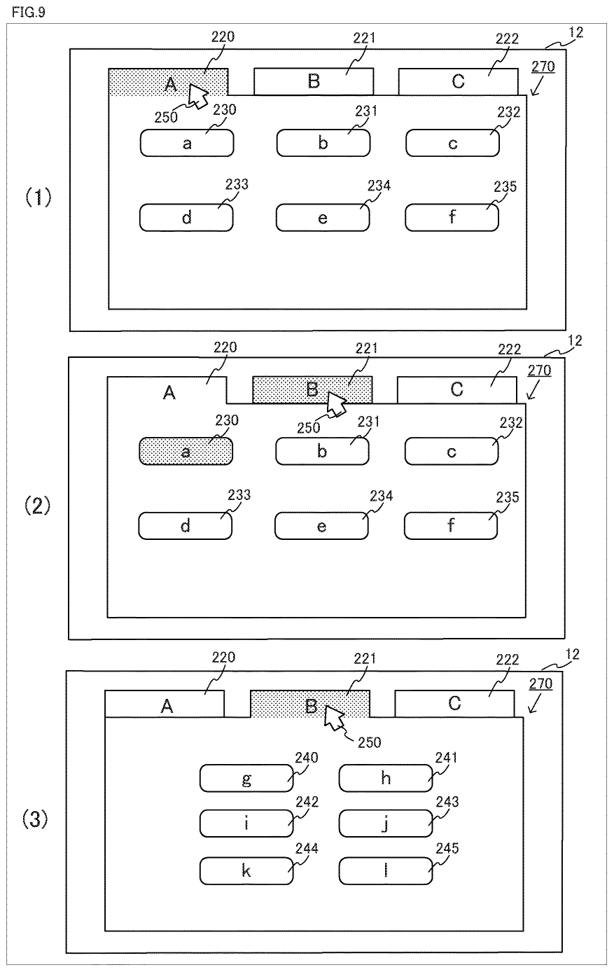

FIG. 8 and FIG. 9 each show an example of a display screen of the mouse operation mode. As shown in FIG. 8(1), in the menu state, a menu 270 is displayed. The menu 270 consists of a menu sheet 220 having tab A, a menu sheet 221 having tab B, and a menu sheet 222 having tab C. In FIG. 8(1), the menu sheet 220 having tab A is displayed at the front, while the other menu sheets are not displayed except for their tabs. On the menu sheet 220, setting items 230 to 235 are arranged. For example, the menu sheet 220 is a sheet for allowing the user to set the abilities of POs. In this game, three POs belong to the same team. For example, the setting item 230 is a button for setting whether or not to emphasize a defense-oriented control tendency during automatic control for each PO, and the setting items 231 to 233 are buttons for setting special skills of each PO.

When transition from the gameplay state to the menu state has been made, the menu 270 is displayed, and the mode becomes a mouse operation mode in which a mouse cursor 250 is displayed (see FIG. 8(1)). The mouse cursor 250 is not displayed in the gameplay state and the direction input operation mode. When transition from the gameplay state to the menu state has been made, as shown in FIG. 8(1), the mouse cursor 250 is displayed at a specified initial position. In the exemplary embodiment, this initial position is the center of the screen. In other exemplary embodiments, the initial position may be another position on the screen.

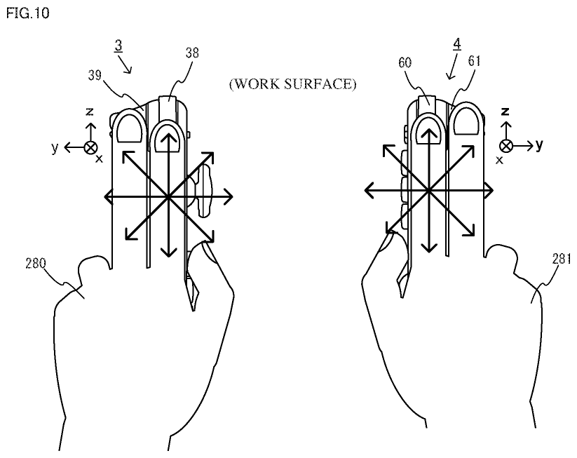

In the mouse operation mode, the mouse cursor 250 moves in response to a mouse operation performed on the left controller 3 or the right controller 4. Details will be described below. FIG. 10 illustrates mouse operations performed on the left controller 3 and the right controller 4 in the mouse operation mode. As shown in FIG. 10, in the mouse operation mode, the user can hold the controllers in the same manner as that in the gameplay state (see FIG. 7).

When a mouse operation is performed to the left controller 3 in the mouse operation mode, the mouse cursor 250 moves in a direction and at a speed corresponding to the mouse operation. Specifically, when the left controller 3 moves in the z-axis positive direction (see FIG. 2, FIG. 10) on the work surface, the mouse cursor 250 moves in the y-axis positive direction shown in FIG. 8(1). When the left controller 3 moves in the z-axis negative direction on the work surface, the mouse cursor 250 moves in the y-axis negative direction shown in FIG. 8(1). When the left controller 3 moves in the y-axis positive direction (see FIG. 2, FIG. 10) on the work surface, the mouse cursor 250 moves in the x-axis negative direction shown in FIG. 8(1). When the left controller 3 moves in the y-axis negative direction on the work surface, the mouse cursor 250 moves in the x-axis positive direction shown in FIG. 8(1). Thus, the movement due to the mouse operation performed on the left controller 3 is reflected as the movement of the mouse cursor 250.

Likewise, when a mouse operation is performed to the right controller 4 in the mouse operation mode, the mouse cursor 250 moves in a direction and at a speed corresponding to the mouse operation. Specifically, when the right controller 4 moves in the z-axis positive direction (see FIG. 3, FIG. 10) on the work surface, the mouse cursor 250 moves in the y-axis positive direction shown in FIG. 8(1). When the right controller 4 moves in the z-axis negative direction on the work surface, the mouse cursor 250 moves in the y-axis negative direction shown in FIG. 8(1). When the right controller 4 moves in the y-axis positive direction (see FIG. 3, FIG. 10) on the work surface, the mouse cursor 250 moves in the x-axis positive direction shown in FIG. 8(1). When the right controller 4 moves in the y-axis negative direction on the work surface, the mouse cursor 250 moves in the x-axis negative direction shown in FIG. 8(1). Thus, the movement due to the mouse operation performed on the right controller 4 is reflected as the movement of the mouse cursor 250.

When mouse operations are simultaneously performed on both the left controller 3 and the right controller 4, the mouse cursor 250 is moved in response to the mouse operation of the controller having a larger amount of movement per unit time (i.e., a higher movement speed). In this case, even if the controller not intended for mouse operation is moved to some extent on the work surface, the mouse cursor 250 can be appropriately moved by the controller intended for mouse operation.

As shown in FIG. 8(2), when the mouse cursor 250 is moved and the tip of the mouse cursor 250 overlaps any one of the setting items, the setting item enters a designated state. In FIG. 8(2), the tip of the mouse cursor 250 overlaps the setting item 230, and the setting item 230 enters the designated state and is changed in color.

As shown in FIG. 8(3), when the L button 38 of the left controller 3 or the R button 60 of the right controller 4 is pressed while the tip of the mouse cursor 250 overlaps the setting item (see FIG. 10), execution of a process corresponding to the setting item overlapped by the tip of the mouse cursor 250 is determined. In FIG. 8(3), the L button 38 of the left controller 3 or the R button 60 of the right controller 4 is pressed while the tip of the mouse cursor 250 overlaps the setting item 230, whereby a process corresponding to the setting item 230 (i.e., setting for emphasizing defense for each PO) is executed, and a check mark is displayed on the setting item 230. Moreover, for example, when the L button 38 of the left controller 3 or the R button 60 of the right controller 4 is pressed while the tip of the mouse cursor 250 overlaps each of the setting items 231 to 233, the text displayed in each of the setting items 231 to 233 may be changed to the name of the special skill currently set for each PO.

As shown in FIG. 9(1) to (3), when the tip of the mouse cursor 250 overlaps any tab, the tab is designated. In FIG. 9(1), the tip of the mouse cursor 250 overlaps the tab A of the menu sheet 220, whereby the tab A is designated and changed in color. In FIG. 9(2), the tip of the mouse cursor 250 overlaps the tab B of the menu sheet 221 that is not displayed in the foreground, whereby the tab B is designated and changed in color.

As shown in FIG. 9(3), when the L button 38 of the left controller 3 or the R button 60 of the right controller 4 is pressed while the tip of the mouse cursor 250 overlaps any tab (see FIG. 10), the menu sheet including the tab overlapped by the tip of the mouse cursor 250 is displayed in the foreground. In FIG. 9(3), the L button 38 of the left controller 3 or the R button 60 of the right controller 4 is pressed while the tip of the mouse cursor 250 overlaps the tab B, whereby the menu sheet 221 is displayed in the foreground. On the menu sheet 221, setting items 240 to 245 for performing settings related to the game stage are arranged.

In the mouse operation mode, execution of the process according to the setting item or the process of displaying the menu sheet in the foreground are determined by the L button 38 or the R button 60 being pressed as described above. Execution of these processes is not determined in response to operation on other buttons or the like of the controller. However, In other exemplary embodiments, execution of these processes may be determined in response to operations on other buttons or the like of the controller.

In the above-described mouse operation mode, when the left stick 32 or the direction buttons (right direction button 33, down direction button 34, up direction button 35, left direction button 36) of the left controller 3 is operated to input a direction, a transition to the direction input operation mode is made. Details of the direction input operation mode will be described below.

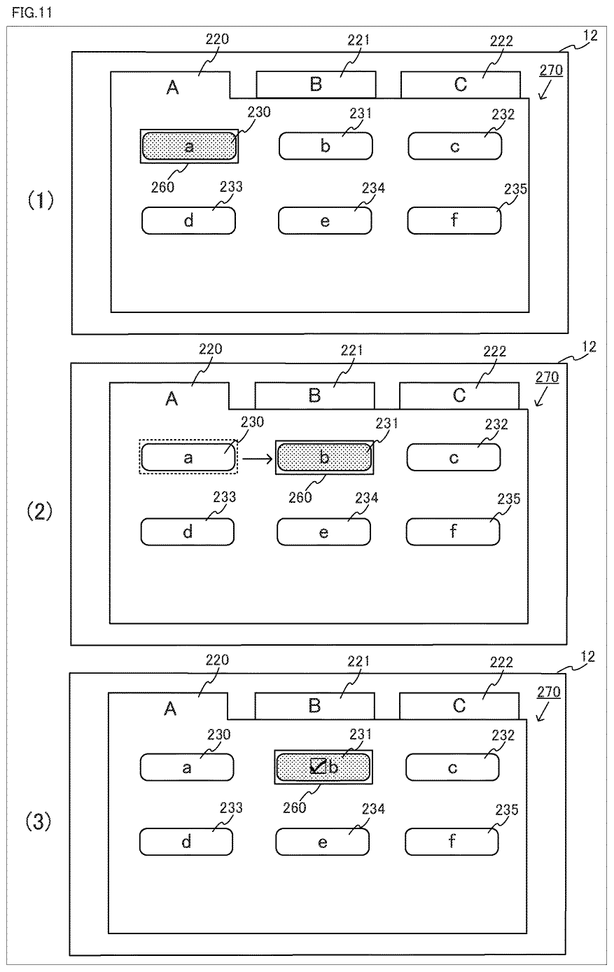

When transition from the mouse operation mode to the direction input operation mode has been made, a frame cursor 260 surrounding a setting item is displayed (see FIG. 11(1)). The frame cursor 260 is not displayed in the gameplay state and the mouse operation mode. When transition from the mouse operation mode to the direction input operation mode has been made, as shown in FIG. 11(1), the frame cursor 260 is displayed for a specified setting item. In the exemplary embodiment, the frame cursor 260 is displayed for the setting item 230 located at the upper left of the screen. In other exemplary embodiments, the frame cursor 260 may be displayed for a setting item located at another position.

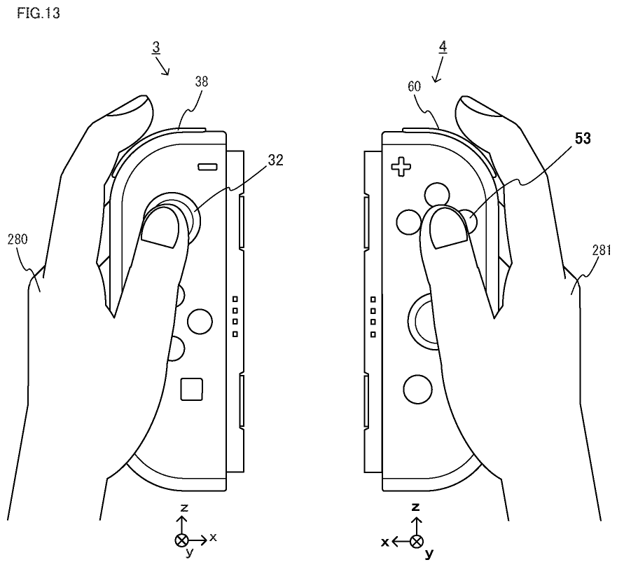

In the direction input operation mode, the frame cursor 260 moves in response to a direction input operation of the left controller 3. The frame cursor 260 does not move in response to a direction input operation of the right controller 4. Details will be described below. FIG. 13 illustrates operations performed on the left controller 3 and the right controller 4 in the direction input operation mode. In the direction input operation mode, the user can hold the left controller 3 and the right controller 4 as shown in FIG. 13.

In the direction input operation mode, when the left controller 3 is subjected to a direction input operation, the frame cursor 260 moves to a setting item in the direction according to the direction input operation. Specifically, when an input in the z-axis positive direction (see FIG. 2, FIG. 13) is performed on the left stick 32 of the left controller 3 or the up direction button 35 (see FIG. 2) is pressed, the frame cursor 260 moves to a setting item on the upper side. When an input in the z-axis negative direction is performed on the left stick 32 of the left controller 3 or the down direction button 34 (see FIG. 2) is pressed, the frame cursor 260 moves to a setting item on the lower side. When an input in the x-axis positive direction (see FIG. 2, FIG. 13) is performed on the left stick 32 of the left controller 3 or the right direction button 33 (see FIG. 2) is pressed, the frame cursor 260 moves to a setting item on the right side. When an input in the x-axis negative direction is performed on the left stick 32 of the left controller 3 or the left direction button 36 (see FIG. 2) is pressed, the frame cursor 260 moves to a setting item on the left side. If there is no setting item in the direction of the direction input operation, the frame cursor 260 does not move, as an example. In addition, the setting item at which the frame cursor 260 is displayed is designated and changed in color.

In FIG. 11(2), an input in the x-axis positive direction (see FIG. 2, FIG. 13) is performed on the left stick 32 of the left controller 3 or the right direction button 33 (see FIG. 2) is pressed, whereby the frame cursor 260 moves to the setting item 231 on the right side, and the color of the setting item 231 is changed.

When any of the buttons 53 to 56 on the front surface of the right controller 4, e.g., the A button 53, is pressed (see FIG. 13), execution of a process corresponding to the setting item at which the frame cursor 260 is displayed is determined. In FIG. 11(3), the A button 53 is pressed, and a process corresponding to the setting item 231 at which the frame cursor 260 is displayed (i.e., setting for the special skill of the PO) is determined to be executed, and a check mark is displayed for the setting item 231.

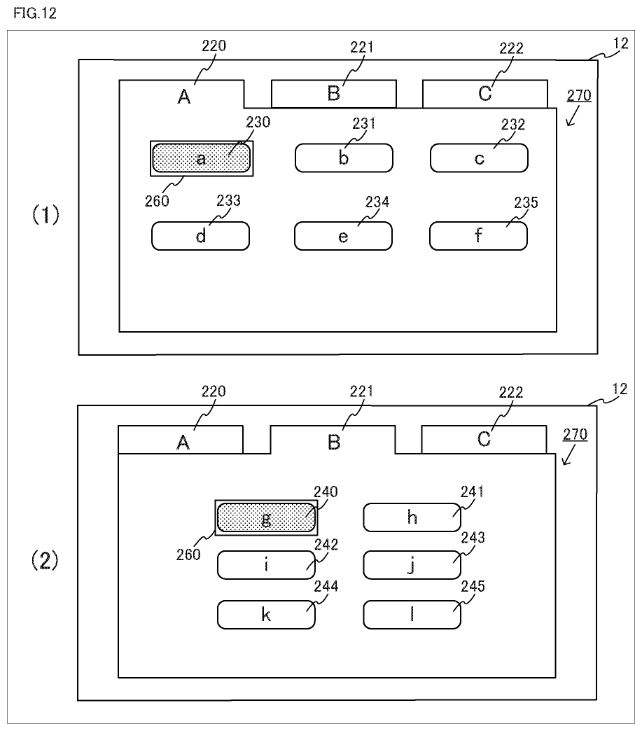

In the direction input operation mode, each time the L button 38 of the left controller 3 or the R button 60 of the right controller 4 (see FIG. 13) is pressed, the menu sheets displayed in the foreground are sequentially switched. Specifically, as shown in FIG. 12(1), when the R button 60 is pressed in the state where the menu sheet 220 is in the foreground, the menu sheet 221 is displayed in the foreground as shown in FIG. 12(2). When the R button 60 is pressed in the state where the menu sheet 221 is in the foreground, the menu sheet 222 is displayed in the foreground. When the R button 60 is pressed in the state where the menu sheet 222 is in the foreground, the menu sheet 220 is displayed in the foreground. Thus, each time the R button 60 is pressed, the menu sheets are sequentially switched and displayed in the foreground. In addition, each time the L button 38 is pressed, the menu sheets are switched and displayed in the foreground in an order opposite to that when the R button 60 is pressed.

In the direction input operation mode described above, when a mouse operation is performed on the left controller 3 or the right controller 4, a transition to the mouse operation mode is made. As already described above, when the plus button 57 of the right controller 4 is pressed in the menu state (i.e., the mouse operation mode or the direction input operation mode), a transition to the gameplay state is made.

In the direction input operation mode, as described above, pressing the A button 53 determines execution of a process corresponding to a setting item. However, execution of this process is not determined in response to operation on other buttons or the like of the controller. However, in other exemplary embodiments, execution of this process may be determined in response to operation on other buttons or the like of the controller.

### Details of Information Processing of Exemplary Embodiment

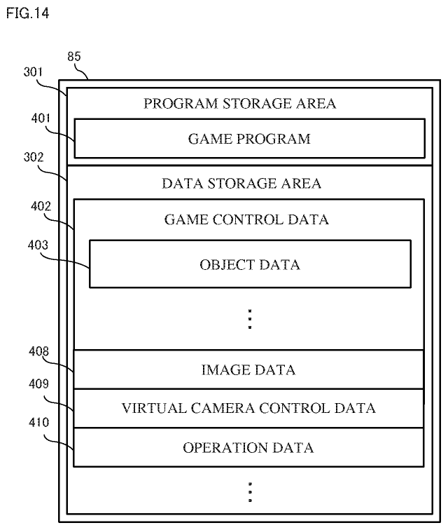

Next, information processing according to the exemplary embodiment will be described in detail with reference to FIG. 14 to FIG. 18.

### Data to be Used

Various data to be used in this game processing will be described. FIG. 14 shows an example of data stored in the DRAM 85 of the game apparatus (game system) 1. As shown in FIG. 14, the DRAM 85 is provided with at least a program storage area 301 and a data storage area 302. A game program 401 is stored in the program storage area 301. In the data storage area 302, game control data 402, image data 408, virtual camera control data 409, operation data 410 etc., are stored. The game control data 402 includes object data 403.

The game program 401 is a game program for executing the processing of this game.

The object data 403 is data of objects to be placed in the virtual space, and is data of objects such as POs (POs 200, 211, etc.), a court (ground), a ball 210, a goal 212, a menu 270, a mouse cursor 250, a frame cursor 260, etc. The object data 403 also includes data of the coordinates, orientation, posture, state, etc., of each object.

The image data 408 is image data of animation images in which the wheels of the PO 200 rotate, backgrounds, virtual effects, etc.

The virtual camera control data 409 is data for controlling the movement of a virtual camera that is placed in the virtual space and captures an image of the virtual space.

The operation data 410 is data indicating the contents of operations performed on the left controller 3 and the right controller 4. The operation data 410 includes, for example, data indicating the movements (including movement due to mouse operation) and posture changes of the left controller 3 and the right controller 4, operations performed on the sticks, and input states for pressed states of various buttons. The contents of the operation data are updated at a specified cycle, based on signals from the left controller 3 and the right controller 4.

In addition, various data to be used in processing in the gameplay state, processing in the menu state, rendering processing, etc., of this game processing are stored in the DRAM 85 according to need.

### Details of Game Processing

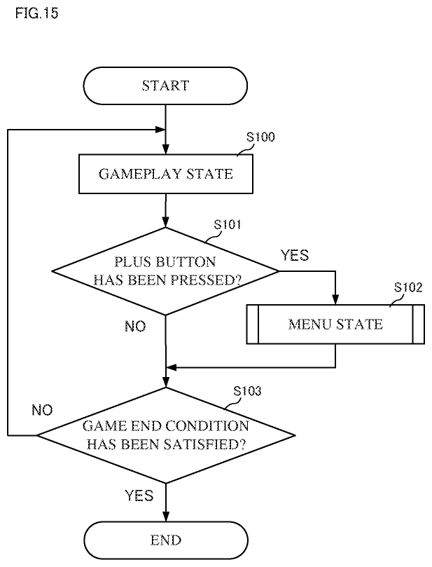

Next, processing according to the exemplary embodiment will be described with reference to flowcharts. FIG. 15 to FIG. 18 are examples of flowcharts showing processing according to the exemplary embodiment. Hereinafter, processing characteristic of the exemplary embodiment will be described, and the description for other processing such as rendering is omitted.

When processing of this game is started and a match in the wheelchair basketball game is started, a process shown in FIG. 15 to FIG. 18 is started. This process is executed at specified intervals (e.g., every rendering frame).

In step S100 in FIG. 15, the processor 81 executes a gameplay state in which a wheelchair basketball match is performed. In the gameplay state, based on the operation data 410, the processor 81 controls the motion of the PO 200 to progress the wheelchair basketball match. Then, the processing proceeds to step S101.

In step S101, based on the operation data 410, the processor 81 determines whether the plus button 57 of the right controller 4 is pressed. When this determination is YES, the processing proceeds to step S102. When this determination is NO, the processing proceeds to step S103.

In step S102, the processor 81 transitions from the gameplay state to the menu state, and executes the menu state.

In step S103, the processor 81 determines whether an end condition for this game is established. This end condition is, for example, the end of the wheelchair basketball match. Then, the processing returns to step S100.

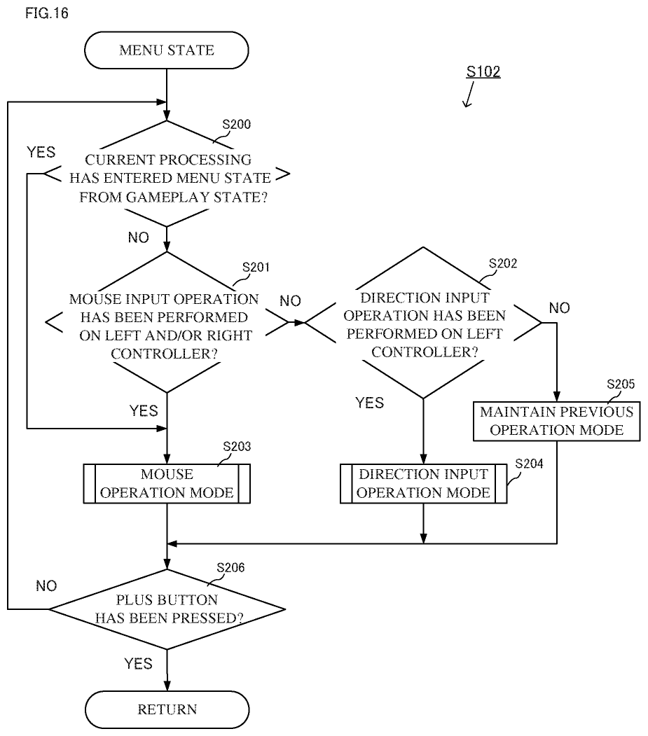

FIG. 16 is an example of a detailed flowchart of the menu state in step S102 shown in FIG. 15.

In step S200 in FIG. 16, the processor 81 determines whether the current processing in the menu state is processing entered upon transition from the gameplay state to the menu state. When this determination is YES, the processing proceeds to step S203. When this determination is NO, the processing proceeds to step S201.

In step S201, based on the operation data 410, the processor 81 determines whether a mouse input operation is performed on the left controller 3 and/or the right controller 4. When this determination is YES, the processing proceeds to step S203. When this determination is NO, the processing proceeds to step S202.

In step S202, based on the operation data 410, the processor 81 determines whether a direction input operation is performed on the left controller 3. When this determination is YES, the processing proceeds to step S204. When this determination is NO, the processing proceeds to step S205.

In step S203, the processor 81 executes the mouse operation mode. Then, the processing proceeds to step S206.

In step S204, the processor 81 executes the direction input operation mode. Then, the processing proceeds to step S206.

In step S205, the processor 81 executes the operation mode (mouse operation mode or direction input operation mode) executed in the previous processing. Then, the processing proceeds to step S206.

In step S206, based on the operation data 410, the processor 81 determines whether the plus button 57 of the right controller 4 is pressed. When this determination is YES, the processing proceeds to step S103 in FIG. 15. When this determination is NO, the processing returns to step S200.

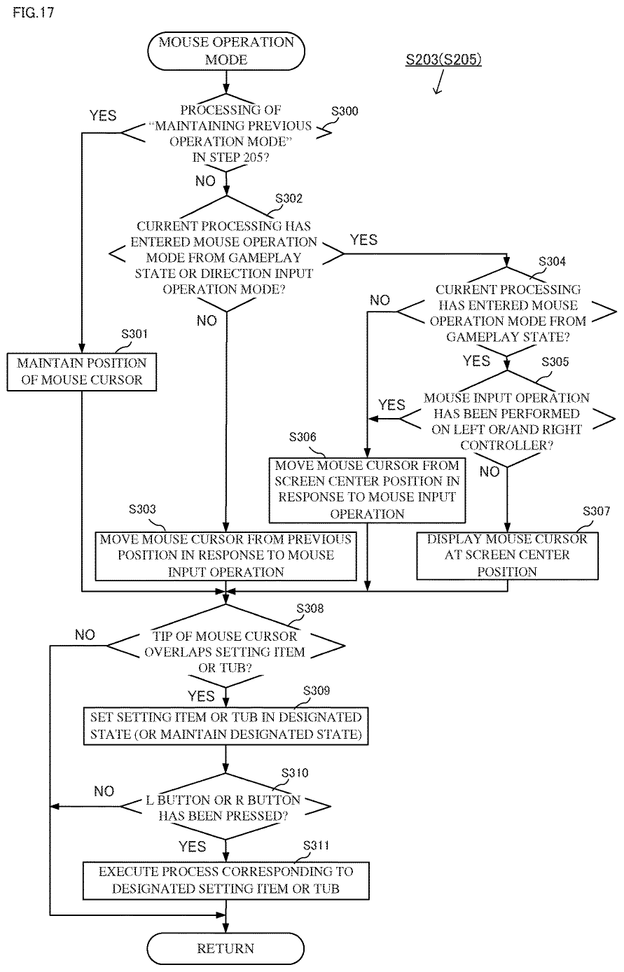

FIG. 17 is an example of a detailed flowchart of the mouse operation mode executed in step S203 or S205 shown in FIG. 16.

In step S300 in FIG. 17, the processor 81 determines whether the current processing in the mouse operation mode is processing of “maintaining the previous operation mode” in step S205 in FIG. 16. In other words, the processor 81 determines whether the current processing in the mouse operation mode is processing of executing the mouse operation mode in step S205 in FIG. 16. When this determination is YES, the processing proceeds to step S301. When this determination is NO, the processing proceeds to step S302.

In step S301, the processor 81 maintains the display position of the mouse cursor 250 without moving the same. Then, the processing proceeds to step S308.

In step S302, the processor 81 determines whether the current processing in the mouse operation mode is processing entered upon transition from the gameplay state or the direction input operation mode to the mouse operation mode. When this determination is YES, the processing proceeds to step S304. When this determination is NO, the processing proceeds to step S303.

In step S303, the processor 81 moves the mouse cursor 250 from the previous position in response to the mouse input operation in step S201 in FIG. 16 (see FIG. 8(2)). Then, the processing proceeds to step S308.

In step S304, the processor 81 determines whether the current processing in the mouse operation mode is processing entered upon transition from the gameplay state to the mouse operation mode. When this determination is YES, the processing proceeds to step S305. When this determination is NO, the processing proceeds to step S306.

In step S305, based on the operation data 410, the processor 81 determines whether a mouse input operation is performed on the left controller 3 and/or the right controller 4. When this determination is YES, the processing proceeds to step S306. When this determination is NO, the processing proceeds to step S307.

In step S306, the processor 81 moves the mouse cursor 250 from the center position of the screen in response to the mouse input operation based on the operation data 410 (see FIG. 8(1), 8(2)). In this processing, if a mouse input operation is performed on the controller at the same time as a transition is made from the gameplay state to the mouse operation mode (YES in S200, NO in S300, YES in S302, YES in S304, YES in S305), the mouse cursor 250 moves from the center position of the screen in response to the mouse input operation in step S305. Furthermore, in this processing, if a transition is made from the direction input operation mode to the mouse operation mode due to the mouse input operation (NO in S200, YES in S201, NO in S300, YES in S302, NO in S304), the mouse cursor 250 moves from the center position of the screen in response to the mouse input operation in step S201 in FIG. 16. Then, the processing proceeds to step S308.

In step S307, the processor 81 displays the mouse cursor 250 at the center position of the screen (see FIG. 8(1)). In this processing, when a transition is made from the gameplay state to the mouse operation mode, the mouse cursor 250 is displayed at the center position of the screen. Then, the processing proceeds to step S308.

In step S308, the processor 81 determines whether the tip of the mouse cursor 250 overlaps a setting item or a tab. When this determination is YES, the processing proceeds to step S309. When this determination is NO, the processing proceeds to step S206 in FIG. 16.

In step S309, the processor 81 sets, to a designated state, the setting item or tab that is determined in step S308 to be overlapped by the tip of the mouse cursor 250 (see FIG. 8(2), FIG. 9). Then, the processing proceeds to step S310.

In step S310, based on the operation data 410, the processor 81 determines whether the L button 38 of the left controller 3 or the R button 60 of the right controller 4 is pressed. When this determination is YES, the processing proceeds to step S311. When this determination is NO, the processing proceeds to step S206 in FIG. 16.

In step S311, the processor 81 executes a process corresponding to the designated setting item or tab. The process corresponding to the designated setting item is, for example, a setting process in which defense for each PO is emphasized. The process corresponding to the designated tab is, for example, a process of displaying, in the foreground, a menu sheet including the tab (see FIG. 9(2), 9(3)). Then, the processing proceeds to step S206 in FIG. 16.

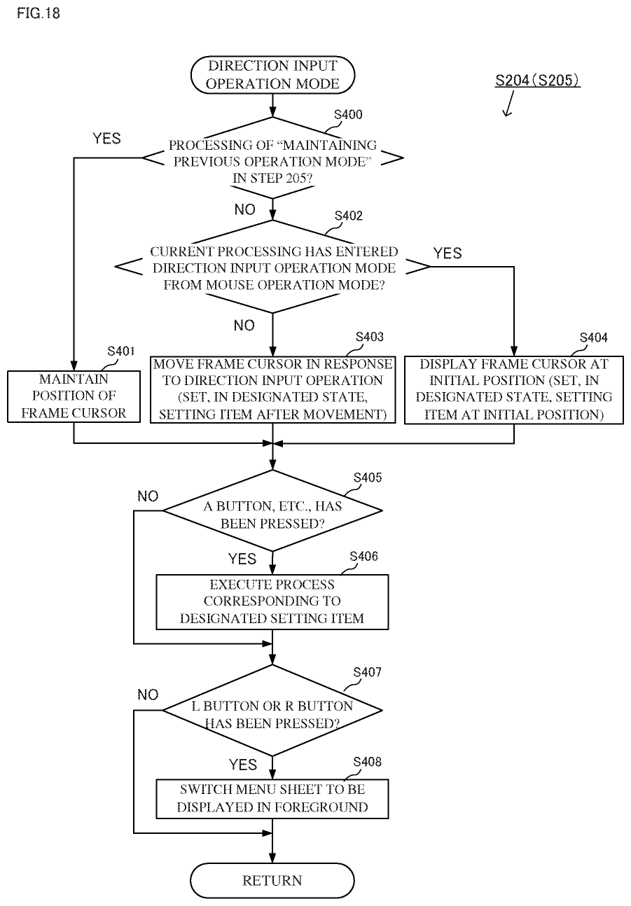

FIG. 18 is an example of a detailed flowchart of the direction input operation mode executed in step S204 or S205 shown in FIG. 16.

In step S400 in FIG. 18, the processor 81 determines whether the current processing in the direction input operation mode is processing of “maintaining the previous operation mode” in step S205 in FIG. 16. In other words, the processor 81 determines whether the current processing in the direction input operation mode is processing of executing the direction input operation mode in step S205 in FIG. 16. When this determination is YES, the processing proceeds to step S401. When this determination is NO, the processing proceeds to step S402.

In step S401, the processor 81 maintains the display position of the frame cursor 260 without moving the same. Then, the processing proceeds to step S405.

In step S402, the processor 81 determines whether the current processing in the direction input operation mode is processing entered upon transition from the mouse operation mode to the direction input operation mode. When this determination is YES, the processing proceeds to step S404. When this determination is NO, the processing proceeds to step S403.

In step S403, the processor 81 moves the frame cursor 260 in response to the direction input operation in step S202 in FIG. 16 (see FIG. 11(2)). In addition, the processor 81 sets, in a designated state, the setting item surrounded by the moved frame cursor 260. Then, the processing proceeds to step S405.

In step S404, the processor 81 displays the frame cursor 260 at the initial position surrounding a specified setting item (see FIG. 11(1)). In this processing, when a transition is made from the mouse operation mode to the direction input operation mode in response to the direction input operation, the frame cursor 260 is displayed at the initial position. Then, the processing proceeds to step S405. In other exemplary embodiments, when a transition is made from the mouse operation mode to the direction input operation mode in response to the direction input operation, the frame cursor 260 may be displayed at a setting item (e.g., setting item 231 in FIG. 11(2)) in the direction corresponding to the direction input operation with respect to the initial position, instead of displaying the frame cursor 260 at the initial position. Alternatively, an animation in which the frame cursor 260 is momentarily displayed at the initial position and then transitions to the setting item in the direction corresponding to the direction input operation, may be displayed.

In step S405, based on the operation data 410, the processor 81 determines whether the A button 53 or the like of the right controller 4 (see FIG. 13) is pressed. When this determination is YES, the processing proceeds to step S406. When this determination is NO, the processing proceeds to step S407.

In step S406, the processor 81 executes processing according to the designated setting item. Then, the processing proceeds to step S407.

In step S407, based on the operation data 410, the processor 81 determines whether the L button 38 of the left controller 3 or the R button 60 of the right controller 4 is pressed. When this determination is YES, the processing proceeds to step S408. When this determination is NO, the processing proceeds to step S206 in FIG. 16.

In step S408, the processor 81 switches the menu sheet to be displayed in the foreground in the menu 270 (see FIG. 12). Then, the processing proceeds to step S206 in FIG. 16.

As described above, according to the exemplary embodiment, in the mouse operation mode, the user can operate the mouse cursor 250 using either a mouse input operation by the left controller 3 or a mouse input operation by the right controller 4 (refer to, for example, the descriptions for FIG. 8 to FIG. 10). Therefore, both right-handed users and left-handed users can easily operate the mouse cursor 250.

According to the exemplary embodiment, in the mouse operation mode, when a mouse input operation by the left controller 3 and a mouse input operation by the right controller 4 are simultaneously performed, the mouse cursor 250 is moved based on the mouse input operation of the controller having a higher movement speed, which is presumed to be the controller that the user intends to operate (refer to, for example, the descriptions for FIG. 8 to FIG. 10). Thus, the mouse cursor can be appropriately moved according to the user's intention.

According to the exemplary embodiment, when a transition is made from the gameplay state in which the game is played through a mouse input operation using the controller (see FIG. 6, FIG. 7) to the menu state, the mode becomes the mouse operation mode in which the mouse input operation is similarly performed (see FIG. 8 to FIG. 10). Therefore, the user can continue performing the mouse input operation without interruption, thereby improving operability.

According to the exemplary embodiment, when a transition is made from the gameplay state or the direction input operation mode to the mouse operation mode, the mouse cursor 250, which is not displayed in the gameplay state and the direction input operation mode, is displayed at a specified position, e.g., the center of the display screen (see FIG. 8(1)), thereby preventing the user from losing track of the mouse cursor 250.

According to the exemplary embodiment, when a transition is made from the mouse operation mode to the direction input operation mode, the frame cursor 260 is displayed at a specified position (see FIG. 11(1), etc.), thereby preventing the user from losing track of the frame cursor 260.

When the user operates a controller while holding it with both hands, it is generally assumed that the user performs a direction input operation using the left thumb. According to the exemplary embodiment, however, in the direction input operation mode, the direction input operation can be performed with the left controller 3 but cannot be performed with the right controller 4 (refer to, for example, the descriptions for FIG. 11 to FIG. 13). Therefore, the user can perform operations without experiencing a sense of discomfort.

According to the exemplary embodiment, a transition is made to the direction input operation mode due to a direction input operation performed in the mouse operation mode, and a transition is made to the mouse operation mode due to a mouse input operation performed in the direction input operation mode (see FIG. 16). Therefore, an additional operation for switching the operation mode is not required, thereby improving operability.

According to the exemplary embodiment, when a mouse input operation and a direction input operation are simultaneously performed, it is highly likely that the user intends the mouse input operation, which requires placing, on the work surface, a surface of the controller on which a mouse sensor is arranged and moving the controller. Therefore, processing corresponding to the mouse input operation is executed (see FIG. 16). Thus, processing that conforms to the user's intention can be performed.

### Modifications

In the exemplary embodiment described above, in the direction input operation mode, the frame cursor 260, which is an object pointing to a setting item, is moved in response to a direction input operation (see FIG. 11). However, in the direction input operation mode, an indicator that points to a setting item may be moved in response to a direction input operation. For example, in the direction input operation mode, instead of the frame cursor 260, a color-change indicator indicating a setting item in a designated state (refer to setting item 230 in FIG. 11(1), setting item 231 in FIG. 11(2), etc.) may be moved in response to a direction input operation.

In the exemplary embodiment described above, the shape of the cursor 260 pointing to a setting item in the direction input operation mode (see FIG. 11) is not limited to a frame. For example, the shape of the cursor may be an arrow.

In the exemplary embodiment described above, when a transition is made from the gameplay state or the direction input operation mode to the mouse operation mode, the mouse cursor 250 is displayed at the center position of the screen which is the initial position (see FIG. 8(1)). However, the position of the mouse cursor 250 at the time of transition from the mouse operation mode to the gameplay state or the direction input operation mode may be stored, and when returning from the gameplay state or the direction input operation mode to the mouse operation mode, the mouse cursor 250 may be displayed at the stored position.

In the exemplary embodiment described above, when a transition is made from the direction input operation mode to the mouse operation mode, the mouse cursor 250 may be displayed at a position indicating a setting item that was surrounded by the frame cursor 260 in the direction input operation mode (e.g., a position at which the tip of the mouse cursor 250 is located at the center of the setting item).

In the exemplary embodiment described above, when a transition is made from the mouse operation mode to the direction input operation mode, the frame cursor 260 is displayed at a specified initial position (see FIG. 11(1)). However, the position of the frame cursor 260 at the time of transition from the direction input operation mode to the mouse operation mode may be stored, and when returning from the mouse operation mode to the direction input operation mode, the frame cursor 260 may be displayed at the stored position.

In the exemplary embodiment described above, when a transition is made from the mouse operation mode to the direction input operation mode, the frame cursor 260 may be displayed for a setting item that was placed in the designated state by the tip of the mouse cursor 250 overlapping the setting item in the mouse operation mode.

In the exemplary embodiment described above, the same cursor may be displayed and operated in both the direction input operation mode and the mouse operation mode, and this cursor may be, for example, a mouse cursor (see FIG. 8).

In the exemplary embodiment described above, when switching modes among the gameplay state, the mouse operation mode, and the direction input operation mode, the left controller 3 and/or the right controller 4 may be vibrated by operating the vibrators (107, 117 in FIG. 5).

In the exemplary embodiment described above, in the menu state, the cursor (250) is moved in response to a mouse input operation, and the cursor (260) is moved in response to a direction input operation (see FIG. 8 to FIG. 13). However, in the gameplay state, a first cursor may be moved in response to a mouse input operation and a second cursor may be moved in response to a direction input operation. For example, it is assumed that, in the gameplay state, there is a scene in which a cursor is used to point to a specified object (specified item). In this scene, the specified object may be pointed to by moving the first cursor in response to the mouse input operation and moving the second cursor in response to the direction input operation. The first cursor and the second cursor may be the same cursor, or may be different cursors. Only one of the first cursor and the second cursor may be displayed, or both of them may be displayed. In information processing that is not game processing, a specified object may be pointed to by moving a cursor in response to a mouse input operation and moving a cursor in response to a direction input operation.

In the exemplary embodiment described above, the cursors (250, 260) are operated in response to a mouse input operation and a direction input operation. However, for example, another object that is not a cursor (e.g., player object) may be operated in response to a mouse input operation and a direction input operation.

In the exemplary embodiment described above, a mouse input operation can be performed using the left controller 3, and a mouse input operation can be performed using the right controller 4. However, a configuration in which a mouse input operation cannot be performed using the left controller 3 whereas a mouse input operation can be performed using the right controller 4, may be adopted.

In the exemplary embodiment described above, a configuration in which, in the direction input operation mode, a direction input operation cannot be performed by the right direction button 33, the down direction button 34, the up direction button 35, and the left direction button 36 of the left controller 3 (see FIG. 2), may be adopted.

The controllers and the information processing apparatus described in the above exemplary embodiment are merely examples, and the configurations and shapes thereof are not limited. For example, the information processing apparatus may be a personal computer, a smartphone, etc. The controllers may not necessarily be attachable and detachable to and from the information processing apparatus.

In the exemplary embodiment described above, the mouse sensor (71, 74) detects movement of the controller (3, 4) on the work surface, and outputs the movement direction, movement amount, etc. However, the mouse sensor may output only data regarding reflected light from the work surface, and the main body apparatus 2 may calculate whether the controller has moved on the work surface, and the movement direction, the movement amount, etc., of the controller, based on the data. Moreover, the main body apparatus 2 or the controller may calculate the current position of the controller in a controller coordinate system, and various types of processing may be executed based on the calculated current position. The same applies to the inertial sensor provided in the controller, and the actual posture, etc., may be calculated by either the main body apparatus 2 or the controller.

In the exemplary embodiment described above, the method for switching between the mouse operation mode and the direction input operation mode is not limited. For example, the switching may be performed in response to a specific button operation, or may be performed in response to the operation of a physical mode selection switch (not shown) provided on at least one of the controllers.

In the exemplary embodiment described above, the analog stick is used as an example of the direction input section (see FIG. 2, etc.). However, instead of the analog stick, a slidable stick or a cross-shaped button, which functions as a direction input section, may be provided on the controller.

In the exemplary embodiment described above, the game program is described as an example of the information processing program (see FIG. 14). However, the information processing program is not limited to the game program. The information processing program may be, for example, a program regarding a system menu in an information processing system. The system menu may be, for example, a menu for selecting a game application to be executed in the information processing system, or may be a menu for setting various functions of the information processing system.

In the exemplary embodiment described above, a case in which a series of processes regarding the game processing are executed in the single game apparatus 1 has been described. In other exemplary embodiments, the series of processes may be executed in an information processing system including a plurality of information processing apparatuses. For example, in an information processing system including a terminal-side apparatus and a server-side apparatus communicable with the terminal-side apparatus via a network, some of the series of processes described above may be executed by the server-side apparatus. Further, in an information processing system including a terminal-side apparatus and a server-side apparatus communicable with the terminal-side apparatus via a network, major processes among the series of processes described above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of so-called cloud gaming may be adopted. For example, a configuration may be adopted in which: the game apparatus 1 sends operation data indicating operations performed by the user to a specified server; various game processes are executed in the server; and the execution result is streaming-distributed as a moving image/sound to the game apparatus 1.

While the exemplary embodiments and modifications have been described above, it is to be understood that the above description is, in all aspects, merely an illustrative example, and is not intended to limit the scope thereof. In addition, it is to be understood that various improvements and changes can be made to the exemplary embodiments and modifications.

What is claimed is:

1. One or more non-transitory computer-readable storage media having stored therein instructions that, when executed, cause one or more processors to perform game operations comprising:
acquiring, from a first input device that has a first direction input section and a first mouse sensor and is held by a left hand of a user, first direction input section operation data in response to an operation performed to the first direction input section by the user, and first mouse operation data in response to movement of the first input device by the user;
acquiring, from a second input device that has a second direction input section and a second mouse sensor and is held by a right hand of the user, second direction input section operation data in response to an operation performed to the second direction input section by the user, and second mouse operation data in response to movement of the second input device by the user;
in a mouse operation mode, moving a first indicator that points to an item displayed, in accordance with the first mouse operation data and the second mouse operation data;
in a direction input operation mode, moving a second indicator that points to the item displayed, in accordance with the first direction input section operation data, without moving the second indicator in accordance with second direction input section operation data; and
executing either the mouse operation mode or the direction input operation mode.

2. The one or more non-transitory computer-readable storage media according to claim 1, wherein the game operations comprise executing:
a gameplay state in which the first indicator and the second indicator are not displayed, and which is progressed in accordance with the first mouse operation data and the second mouse operation data; and
a menu state which is transitioned to from the gameplay state, and in which either the mouse operation mode or the direction input operation mode is executed.

3. The one or more non-transitory computer-readable storage media according to claim 2, wherein the game operations comprise:
causing the first indicator and the second indicator to be different indicators;
not displaying the second indicator in the mouse operation mode, and not displaying the first indicator in the direction input operation mode; and
setting the mode to the mouse operation mode when a transition is made from the gameplay state to the menu state.

4. The one or more non-transitory computer-readable storage media according to claim 1, wherein the game operations comprise:
executing the mouse operation mode when the first mouse operation data indicating movement of the first input device or the second mouse operation data indicating movement of the second input device is acquired; and
executing the direction input operation mode when the first direction input section operation data indicating an operation input to the first direction input section is acquired.

5. The one or more non-transitory computer-readable storage media according to claim 4, wherein the game operations comprise executing the mouse operation mode when at least one of the first mouse operation data and the second mouse operation data, and the first direction input section operation data are acquired.

6. The one or more non-transitory computer-readable storage media according to claim 1, wherein
the first input device includes the first direction input section at a front surface, a first button at an upper surface or a left surface, and the first mouse sensor at a right surface,
the second input device includes the second direction input section and a second button at a front surface, a third button at an upper surface or a right surface, and the second mouse sensor at a left surface, and
the game operations comprise:
in the mouse operation mode, assigning a determination function to the first button and the third button, and not assigning a determination function to the second button; and
in the direction input operation mode, assigning a determination function to the second button, and not assigning a determination function to the first button and the third button.

7. The one or more non-transitory computer-readable storage media according to claim 6, wherein the game operations comprise, in the direction input operation mode, assigning a function of switching the item, to the first button and the third button.

8. The one or more non-transitory computer-readable storage media according to claim 1, wherein
the first indicator is a first object, and
the second indicator is a second object different from the first object.

9. An information processing system comprising one or more processors and one or more non-transitory computer-readable storage media having stored therein instructions that, when executed, cause the one or more processors to perform game operations comprising:
acquiring, from a first input device that has a first direction input section and a first mouse sensor and is held by a left hand of a user, first direction input section operation data in response to an operation performed to the first direction input section by the user, and first mouse operation data in response to movement of the first input device by the user;
acquiring, from a second input device that has a second direction input section and a second mouse sensor and is held by a right hand of the user, second direction input section operation data in response to an operation performed to the second direction input section by the user, and second mouse operation data in response to movement of the second input device by the user;
in a mouse operation mode, moving a first indicator that points to an item displayed, in accordance with the first mouse operation data and the second mouse operation data;
in a direction input operation mode, moving a second indicator that points to the item displayed, in accordance with the first direction input section operation data, without moving the second indicator in accordance with second direction input section operation data; and
executing either the mouse operation mode or the direction input operation mode.

10. The information processing system according to claim 9, wherein the game operations comprise executing:
a gameplay state in which the first indicator and the second indicator are not displayed, and which is progressed in accordance with the first mouse operation data and the second mouse operation data; and
a menu state which is transitioned to from the gameplay state, and in which either the mouse operation mode or the direction input operation mode is executed.

11. The information processing system according to claim 10, wherein the game operations comprise:
causing the first indicator and the second indicator to be different indicators;
not displaying the second indicator in the mouse operation mode, and not displaying the first indicator in the direction input operation mode; and
setting the mode to the mouse operation mode when a transition is made from the gameplay state to the menu state.

12. The information processing system according to claim 9, wherein the game operations comprise:
executing the mouse operation mode when the first mouse operation data indicating movement of the first input device or the second mouse operation data indicating movement of the second input device is acquired; and
executing the direction input operation mode when the first direction input section operation data indicating an operation input to the first direction input section is acquired.

13. The information processing system according to claim 12, wherein the game operations comprise executing the mouse operation mode when at least one of the first mouse operation data and the second mouse operation data, and the first direction input section operation data are acquired.

14. The information processing system according to claim 9, wherein
the first indicator is a first object, and
the second indicator is a second object different from the first object.

15. A computer-implemented method comprising:
acquiring, from a first input device that has a first direction input section and a first mouse sensor and is held by a left hand of a user, first direction input section operation data in response to an operation performed to the first direction input section by the user, and first mouse operation data in response to movement of the first input device by the user;
acquiring, from a second input device that has a second direction input section and a second mouse sensor and is held by a right hand of the user, second direction input section operation data in response to an operation performed to the second direction input section by the user, and second mouse operation data in response to movement of the second input device by the user;
in a mouse operation mode, moving a first indicator that points to an item displayed, in accordance with the first mouse operation data and the second mouse operation data;
in a direction input operation mode, moving a second indicator that points to the item displayed, in accordance with the first direction input section operation data, without moving the second indicator in accordance with second direction input section operation data; and
executing either the mouse operation mode or the direction input operation mode.

16. The computer-implemented method according to claim 15, comprising executing:
a gameplay state in which the first indicator and the second indicator are not displayed, and which is progressed in accordance with the first mouse operation data and the second mouse operation data; and
a menu state which is transitioned to from the gameplay state, and in which either the mouse operation mode or the direction input operation mode is executed.

17. The computer-implemented method according to claim 16, comprising:
causing the first indicator and the second indicator to be different indicators;
not displaying the second indicator in the mouse operation mode, and not displaying the first indicator in the direction input operation mode; and
setting the mode to the mouse operation mode when a transition is made from the gameplay state to the menu state.

18. The computer-implemented method according to claim 15, comprising:
executing the mouse operation mode when the first mouse operation data indicating movement of the first input device or the second mouse operation data indicating movement of the second input device is acquired; and
executing the direction input operation mode when the first direction input section operation data indicating an operation input to the first direction input section is acquired.

19. The computer-implemented method according to claim 18, comprising executing the mouse operation mode when at least one of the first mouse operation data and the second mouse operation data, and the first direction input section operation data are acquired.

20. The computer-implemented method according to claim 15, wherein
the first indicator is a first object, and
the second indicator is a second object different from the first object.
